(19) United States
(12) Patent Application Publication
(10) Pub. No.: US 2016/0183717 A1
(43) Pub. Date: Jun. 30, 2016

(54) IMPROVED APPARATUS FOR THE PREPARATION OF ONE OR A PLURALITY OF BEVERAGES

(71) Applicant: OSMAP ASIA PACIFIC PTE. LTD., Singapore (SG)

(72) Inventors: Adriano OSTAN, Singapore (SG); Michele FANTIN, Brugnera (PN); Ivan OSTAN, Singapore (SG)

(21) Appl. No.: 14/901,039

(22) PCT Filed: Jun. 25, 2014
(86) PCT No.: PCT/IB2014/062589

§ 371 Date: Dec. 27, 2015

(30) Foreign Application Priority Data
Jun. 26, 2013 (IT) PN2013A000035

(51) Int. Cl. A47J 31/56; A47J 31/46; A47J 31/30

(52) U.S. Cl. CPC A47J 31/56; A47J 31/30; A47J 31/46

(57) ABSTRACT

An apparatus for preparing hot beverages includes a water reservoir, a boiler arranged under the reservoir and connected to the inside of the reservoir by a first conduit, a water heating resistance arranged in the boiler, an infusion chamber with a cover and a filtering element for a definite quantity of product subjected to infusion. In one alternative, the apparatus is used for preparing a single dose of beverage through pressure infusing, or in another alternative, for the preparation of a beverage in multiple doses using a filter and by percolating through a filter. The apparatus includes an accessory for containing a quantity of product for a single dose, housed within the infusion chamber in place of the filter. The upper opening of the accessory could be closed by the lower surface of the cover when it closes the infusion chamber. An electrical power supply is also included.

The present invention refers to an apparatus for domestic or professional use suitable to enable a user to prepare hot beverages, in particular coffee, with methods that allow the preparation of both a single dose or multiple doses in an autonomous mode, for example about 8 cups or even more of a desired beverage.

In general, the machines for the preparation of hot beverages, in particular coffee, are characterized, in both their construction and operating mode, principally:
by the number of doses that can be prepared in a single operation;
and by the mode of preparation of the beverage (filter/infusion).

The present invention refers an apparatus for the preparation of beverages, starting from proportioned ingredients, preferably for the preparation of coffee of the “pour-over” or “filter” type, as well as for the preparation of coffee or other beverages infused and extracted at pressures varying from atmospheric to low operating pressures, using capsules or cartridges, or pods or “bags”, or prepacked tablets, preferably with a dose of roasted or ground coffee contained therein, but also with other types of ingredients or preparations like, for example, tea, barley, fruit infusions, chamomile, etc., suitable to be extracted therefrom. In the same manner, these ingredients or preparations can also be suitable for dissolving, diluting or mixing with hot water, as in the case of soluble, freeze-dried or concentrated substances.

In the following description, in order to define and identify the type of packet/container of the substance used to prepare the beverage, as for example the capsules or cartridges, or pods, “bags”, or tablets, the term “PACKET” will be used in its general connotation, meaning with this term the particular type of packet most suitable or used for each particular type of substance contained therein.

Typically, the filtered coffee or the coffee obtained with the “pour-over” method does not produce cream or foam, unlike the coffee obtained through extraction by pressure or with other systems that force the water through the substance to be expressed. On the other hand, using positive-displacement pumps suitable for extracting coffee or other substances by pressure, it is often difficult to obtain very abundant flows (typically from 5 to 15 cc/sec) at atmospheric pressure that match flows of 1-3 cc/sec at maximum pressure; moreover, it is very difficult to avoid the formation of said creams or foams visibly present on the beverage.

When continuous-flow heat exchangers of the “instant” type are used, due to their nature of small mass and often very high thermal capacity, in order to work well they require a sophisticated temperature control with a very fast temperature detection capacity and very low thermal inertia, which normally requires an electronic control system. Unfortunately, these thermal control systems using microprocessors and high-speed and lightweight temperature detection components are often relatively costly and not always reliable for the potentially high temperatures that can be reached by the heat exchanger in case of lack of water.

In fact, the common systems for the preparation of “filter” coffee, normally do not make use of advanced thermal control systems, partly because they do not require a high degree of thermal precision for its preparation, unlike the coffee prepared under pressure with low flows, like for example espresso coffee, where temperature is a very critical factor for the success of the preparation.

A known method for delivering in a few seconds a measured quantity of water at a very precise temperature consists of preheating the water and maintaining its temperature in a boiler, and to draw it out when required for use. This makes it possible to have a less complex thermal control with common, relatively simple and economical control components, as for example bimetallic thermostats.

Some disadvantage of this method are linked to the thermal inertia of the boiler: when the apparatus is switched on, the boiler is at ambient temperature and requires a relatively long waiting time for it to heat up, due to the total mass of the boiler and the water in it.

In the second place, the greater thermal inertia of the boiler filled with water makes it more difficult to have an instant or fast change of temperature, in the case in which the substance to be extracted requires a different thermal condition.

A third disadvantage of the boiler system is the fact that, due to said thermal inertia, it causes a greater waste of energy because it must be switched on long before and held at a high temperature even when there is no preparation of the beverage required, resulting in a generally higher energy consumption. This also applies for massive, and therefore not instant, continuous-flow heat exchangers.

For these reasons, especially in the household uses, where the preparation of beverages is less frequent and repetitive, and where there is a greater support of energy economy, the systems for the preparation of thermally inert hot beverages is becoming less and less desired.

The known new generation systems of instant type, which include automatic switch-off systems, which are almost always based on electronic control systems, cause further excessive levels of energy consumption.

The fact that there is a “slowed-down” automatic switch-off system, thus with a tolerated time lapse between the last use and the effective switching off, causes or promotes the negative tendency of leaving the apparatus always switched on, since it is switched off by itself.

This habit works against the final objective of the automatic switching-off system, which is a reduction of the overall energy consumption.

While previously the tendency was to switch the apparatus off with the power switch immediately after its use, knowing that there was no automatic switch-off system, now the apparatus is very often left switched on until it is automatically switched off.

Thus, by further shortening the time from the last use to the effective automatic switching off, this further waste of energy can be minimized.

One particular disadvantage of the coffees of “filter” (or “drip”) type, prepared at atmospheric pressure with continuous-flow heat exchangers, lies in the fact that they require, especially for large quantities of beverages, too much time for the preparation (drip by drip). The waiting time is not only an unfavourable factor for the user who wishes the beverage to be instantly served, but also causes some repercussions on the quality of the beverage obtained.

One consequence of the longer time necessary for the drip-by-drip preparation is the fact that the longer preparation time and a smaller thermal control of the water poured on the coffee leads to the necessity of further maintaining the temperature of the beverage already served, often performed however in a scarcely appropriate manner.

Usually, glass headers that are not heat insulated are used, combined with an additional heat source placed under the header, supplied by the heat generated by the same continuous-flow heat exchanger. Unfortunately, this latter method causes a considerable degradation of the quality of the infused beverage, which with the time it remains on the heat source becomes increasingly bitter and astringent, in addition to losing the extracted volatile aromas.

It is also known that in the drip-by-drip preparation, the “drip” coffee does not favour an effective mix of hot water with the ground coffee placed in the filter.

In fact, more coffee must usually be used than with other methods, like for example compared to the coffee obtained by extractions with hot water under pressure (espresso) or to the “pour-over” coffee, obtained from repeated pourings of larger portions of water directly on the coffee placed in the filter.

There are also less common systems that propose a process based on the historically used manual mode of “filter coffee” preparation: the “pour-over”, in which measured portions of hot water are repeatedly poured manually or automatically on the coffee placed in the filter. In this manner, the coffee is not only infused in a faster manner but also there is a better mixing of the coffee with the hot water.

In like manner, also other substances to be infused, such as for example tea, barley or fruit infusions, chamomile, suitable for infusion or extraction, can benefit from the whirling movements of the water that is cyclically poured into the filter.

Two main disadvantages of the “pour-over” method, if performed manually, are the requirement that the user be present during the preparation and the experience necessary to perform it in a safe and controlled manner. Moreover, once the needed quantity of water is heated with the boiler or by other means, it begins to cool, potentially failing to extract in the best manner the pourings of hot water after the first one.

There are also systems of cyclical (not manual) pour-overs that function autonomously, but are often suggested for professional, not household, uses due to their greater cost and are arranged for large quantities of beverages.

There are also pour-over systems intended for household use, but they are designed with boiler systems that maintain a quantity of water ready for use with a conspicuous energy consumption and a relatively long preheating time. Usually, these systems are suitable for the gravity percolation/fast infusion of more than one cup and are not indicated for the occasional use of single extractions with capsules, cartridges, pods, tablets of prepacked tablets.

The extensive use of household systems and machines for the preparation of beverages, based on portioned products contained in single packets, expands along with an increasing necessity of adapting such machines to the spaces available in the home environments in which they are installed.

However, the technical possibilities to achieve this objective are in great part aimed at limiting the size of the machines, through a redesign of the internal parts that could affect the holding capacity of the tanks; consequently, there is the necessity of filling them often or even with every preparation.

In the following description will be mentioned and discussed some of the most typical and/or interesting embodiments of machines for the preparation of single-dose and multiple-dose beverages, and will be discussed some of their main characteristics and relative limits.

The most significant patents will be discussed in a more complete manner, while the less significant patents will naturally be described only briefly.
EP 0 562 297 B1

This patent concerns an apparatus for brewing hot beverages, like coffee, tea or other brews; it is provided with a water reservoir and a boiler, in which the conduit (riser 7) from the boiler to the receptacle containing the filter, and the vent pipe (12) from the same boiler, are equipped with suitable valves.

Said patent has produced a type of apparatus for the preparation of hot beverages in an intermittent but substantially automatic mode, and has noticeably improved the prior art; however, it does not offer a possibility of selectively brewing both a single dose of beverage and a plurality of doses at the same time because there is no provision for adapting the receptacle containing the filter, and also because of its automatic mode of operation.
EP 0 781 520 A1

This patent is relative to the preparation of both single cups of coffee and multiple doses in a percolator of conventional type; however, it cannot brew an infused beverage because the “pour over” method is used even in the case of a single beverage.
EP 0687 436 B1 concerns the control of the electrical input of a pump on an apparatus for the preparation of coffee; this element makes the apparatus rather complex and costly, and not suitable for a household application.
MX 2010010 486 A

This patent discloses a solution for an apparatus that allows both a single-dose preparation and the preparation of multiple beverages.

However, this patent discloses a solution of a piston that regulates the pressure of the substance that is infused by the water, and thus it does not allow the “pour-over” mode.
MX 2010011635 A

This patent discloses a solution in which a head with a plurality of perforations sprays a like number of jets inside a percolating vessel of conventional type; it does not provide a means for the production of a single coffee dose.
MX 2010011990 A

This patent discloses a solution for controlling the positive or negative pressure in an apparatus preparation of coffee; in this case, too, no means is provided for brewing a single dose of coffee.
MX 2010011993 A

This patent discloses an improvement of the internal mechanisms in an apparatus for the preparation of coffee; in this case, too, there is no means for the production of both a multiple dose of coffee, or of a single dose of coffee.
U.S. 2013/0004629

This patent uses two or more different adapters, each of which is suitable to prepare a different number of beverages, and also a spray head, fed by a relative pump; since it is still necessary to install an adapter, the implementation of this patent is needlessly complicated.
WO 2012/122118 A2

This patent discloses a rather complex mechanical device for compacting the ground coffee or other product.

In this case, too, there is no description of means for brewing either a multiple dose of coffee or a single dose of coffee.
GB 2403401 discloses an apparatus for the preparation of infusions, such as tea, espresso coffee, filtered (drip) coffee, etc.; said apparatus is suitable to treat such types of different brews, which require different working pressures, which is possible with the addition of respective accessories, each of which being suitable for a particular beverage, combined with the provision of a respective, differentiated infusion pressure.

Said differentiated brewing pressure is achieved either by using a relative pump that increases the pressure of the water when it is introduced into the substance with which to make the brew, or by selecting the desired pressure by forcing the water under pressure to flow in a different respective path, in which is inserted a relative pressure regulating element, downstream of which is fed a flow of water at the selectively adjustable pressure.

However, this solution requires the use of fairly complex and costly devices, such as a hydraulic pump, different water flow conduits, means or valves for diverting the water flow through said different conduits.

Moreover, although this solution makes it possible to prepare different types beverages or infusions, it does not in any way allow a more flexible use, such as in other words the preparation of beverages in both a single dose and in multiple doses through the use of accessories or adapters or infusion chambers of remarkably different respective volumes.

U.S. Pat. No. 4,054,085 discloses a special adapter to utilize a container suitable to contain a quantity of coffee sufficient for 12 cups of coffee instead of a standard container sufficient for a quantity of coffee for 8 cups.

However, this solution does not meet the need to prepare a single dose of coffee, since the solution is aimed at a totally different purpose; moreover, the apparatus remains substantially unchanged, since the only variation consists of an adapter that only makes it possible to increase the size of the container of the coffee that can be held and used.
WO 2004/008922 discloses a multi-function apparatus for the production of an infused beverage, such as coffee, that can also work simply as a water boiler; however, this solution does not in any way solve the problem of brewing selectively a single dose of beverage or a multiple dose.
WO 2012/2001115 discloses a solution that tends to solve the problem of using a single apparatus for the preparation of beverages of different types and that require containers of specific and different type, also for the purpose of eliminating any possibility of contamination with or mixing of different beverages.

This objective is achieved by associating a single chamber for brewing an infusion beverage, a plurality of different capsule-holding adapters, each suitable to contain a single capsule of product, in which said various capsules are alternatively or selectively inserted in said single infusion chamber.

However, said infusion chamber naturally has a constant volume, and thus it does not in any way solve said problem of being able to prepare in a simple and selective manner, with the same apparatus, both a single beverage, and a quantity sufficient for a plurality of beverages at the same time.
GB 2491341 describes the use of a conventional household coffee machine (moka coffee, espresso) in a single dose, and the possibility of associating with it an adapter that allows both the use of infusion products other than coffee, and avoids the unpleasant and imperfect task of cleaning the machine after every use; this apparatus does not, however, appreciably modify the quantity of coffee or other infusion beverage that can be prepared.
WO 2006/066621 discloses an apparatus for the preparation of coffee or other similar beverages, equipped with an improved feature that makes it possible to modify, within certain limits, the number of cups that can be prepared in a continuous sequence with the same beverage and with the same product from which the infusion is extracted.

According to said improved feature, the volume of the infusion chamber is not modified, but within it is arranged a relative adapter (holder 14) that is provided with the possibility of modifying its internal volume by displacing and/or overturning its lid (12) with respect to the bottom wall of the same adapter; in said variable-volume internal space can be arranged one or more capsules or bags of the product that is to be infused, thus significantly improving the flexibility of the service offered by the same apparatus.

However, a strict limit to the use of said apparatus is imposed by the fact that the quantity of water turned into a beverage depends essentially on the quantity placed into the infusion chamber, and not on the volume of the infusion chamber itself, since that is substantially constant.

Thus, it is possible to prepare only one dose or at most 2 or 3 doses of beverages, and not the quantity of doses that are currently requested, from 5 to as many as 12.

In addition, the apparatus also has the drawback that in every case it is necessary to use, fill and install the adapter 14, even if a maximum quantity of beverage is produced.
U.S. Pat. No. 5,669,287 discloses an apparatus for the preparation of tea or coffee, in which the quality of the beverage prepared depends substantially on the infusion time that must be regulated and controlled with relative devices; it is evident that this apparatus is not suitable for the preparation of single doses of coffee, and that it is rather complicated due to the necessity of having complex and costly control devices.
DE 20 2004 008637 (WO 2004/105564) discloses an apparatus for the preparation of beverages, in particular coffee, in which the brewing chamber is provided with a shaped bottom wall; the internal volume of said brewing chamber is modified by displacing and overturning said bottom wall, thus making it possible to prepare different numbers of beverages.

However, this solution is adversely affected by the twofold limit that however all the beverages must always be infused, and also that the maximum and minimum number of doses that can be prepared varies very little.

The main objective of the present invention is to obviate the shortcomings of the prior art, by providing an apparatus preparation of beverages, starting from proportioned ingredients, that is of compact size but that however embodies two types of preparation of beverages, varying from one cup at a time using single-dose packets at low pressure, up to the independent preparation of 8 cups or more.

In greater detail, the objectives of the present invention are the following:

1. Provide a two-sided solution to enable the use of the two most common methods of infusion and percolation in a single system: multiple cups with ground coffee powder of the filter type, and single cup with a single-dose packet, suitable in particular for making coffee, but not excluding other types of beverages, such as tea, barley, etc.

2. Provide a faster solution, more efficient from the energy point of view and more appreciated for its organoleptic quality with respect to the “drip” method: the so-called cyclic pour-over for at least half a dozen cups of about 200-260 cc in an autonomous manner.

3. Create an apparatus that provides through simple means an automatic switch-off system after a single cup/serving, but that also offers the possibility of autonomous cyclical servings, with a low energy impact and of simple construction, ensuring reliability, safety and quality.

4. Provide a solution that requires very few fast operations in order to be able to change from one type of infusion to another.

5. Provide a fast solution with low thermal inertia, that is capable of offering a beverage within a very short time after switching on.

6. Provide a solution that is capable of adapting and work in a relatively simple and fast manner with various types and forms of single packets with a single adapter for each type of packet.

Such an apparatus must be such as to be feasible with readily available technologies, and guarantee a sure and easily practicable result.

This and other objectives are achieved by an apparatus for the preparation of beverages according to the enclosed claims.

Characteristics and advantages of the invention will become evident from the description which follows, by way of example and without limitations, with reference to the enclosed drawings, in which:

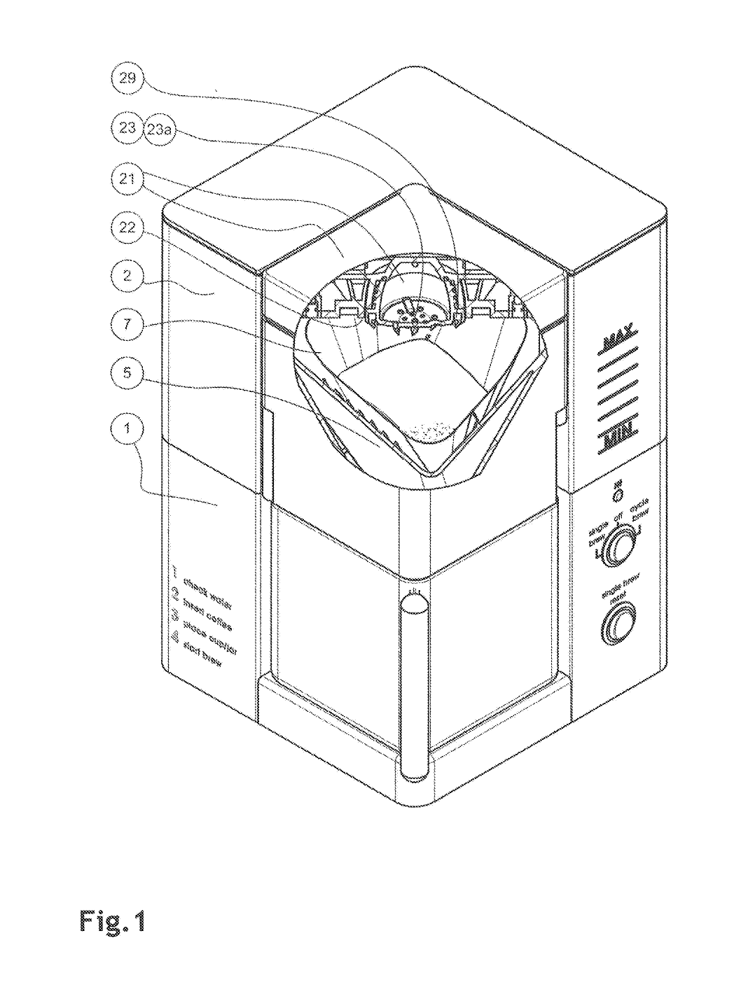

FIG. 1 illustrates an external perspective view partially in section of an apparatus according to the invention in a first operating mode;

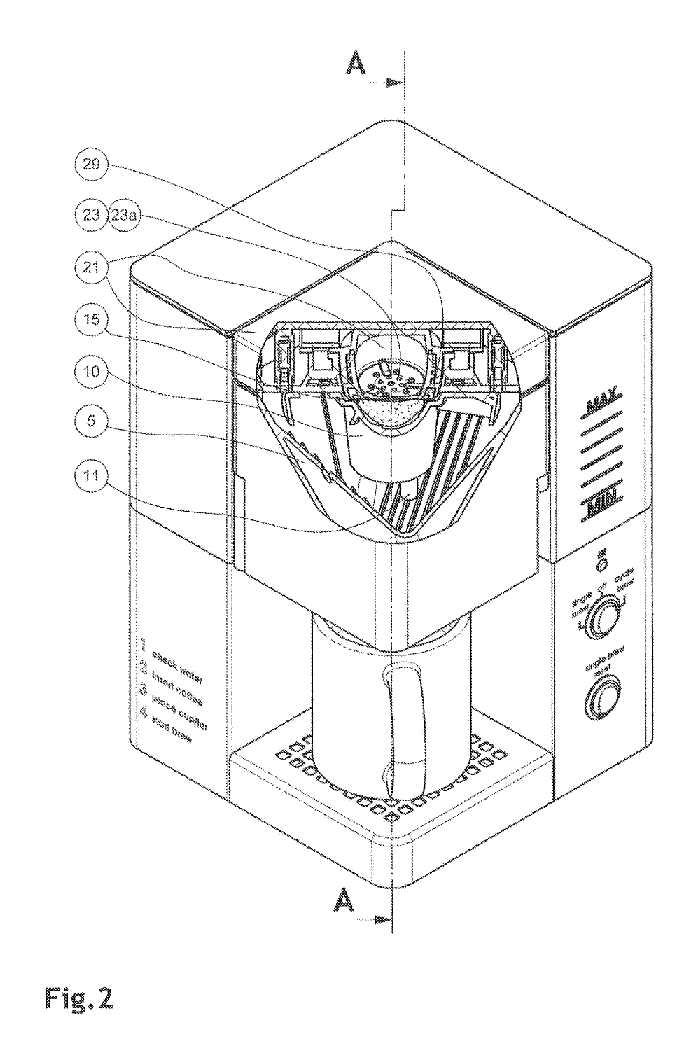

FIG. 2 illustrates a view similar to FIG. 1, but in a second operating mode;

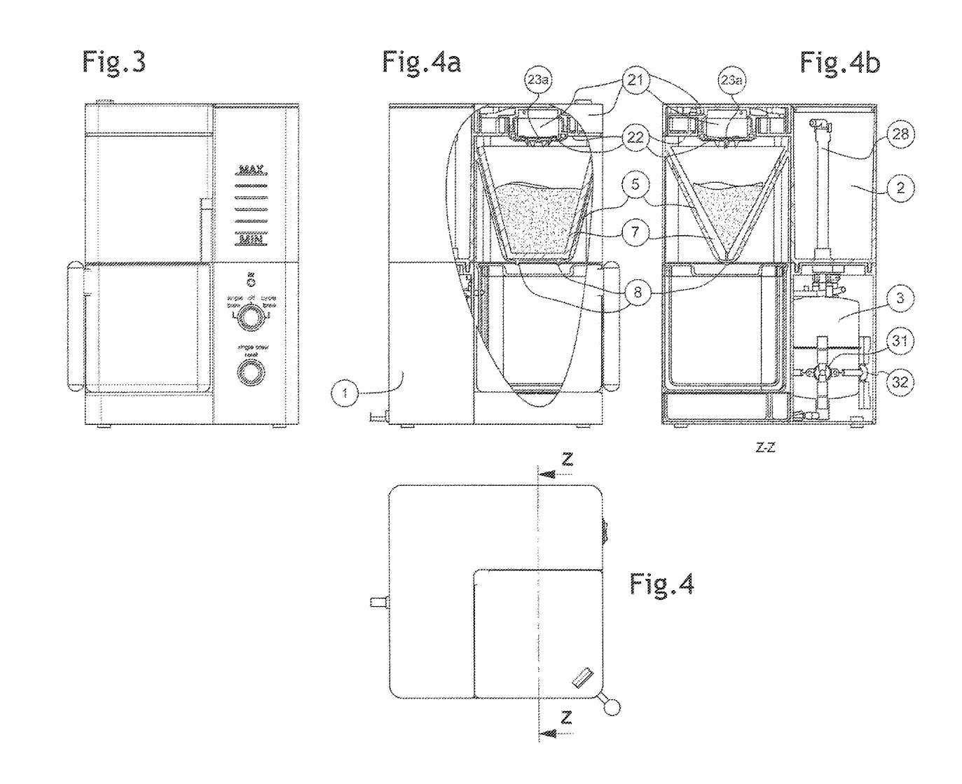

FIG. 3 is a plane side view of the apparatus according to FIG. 1;

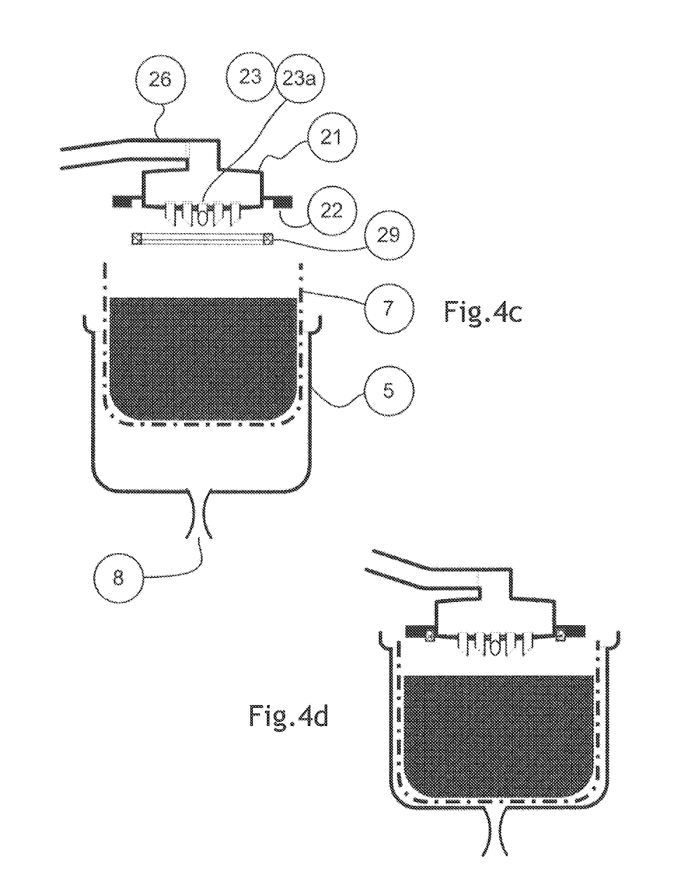

FIG. 4 is a top view of an apparatus shown in FIGS. 1 and 2;

FIGS. 4a and 4b illustrate respectively a view partially in cross section of the apparatus of FIG. 4, and a vertical cross section along the sectional plane Z-Z of FIG. 4, provided with a first prearrangement of an apparatus according to the invention;

FIG. 4c illustrates an exploded view and in simplified form of a portion of the apparatus shown in FIGS. 4 and 4b, provided with the first prearrangement according to the invention;

FIG. 4d illustrates the same portion of the apparatus of FIG. 4c, but shown in an assembled mode;

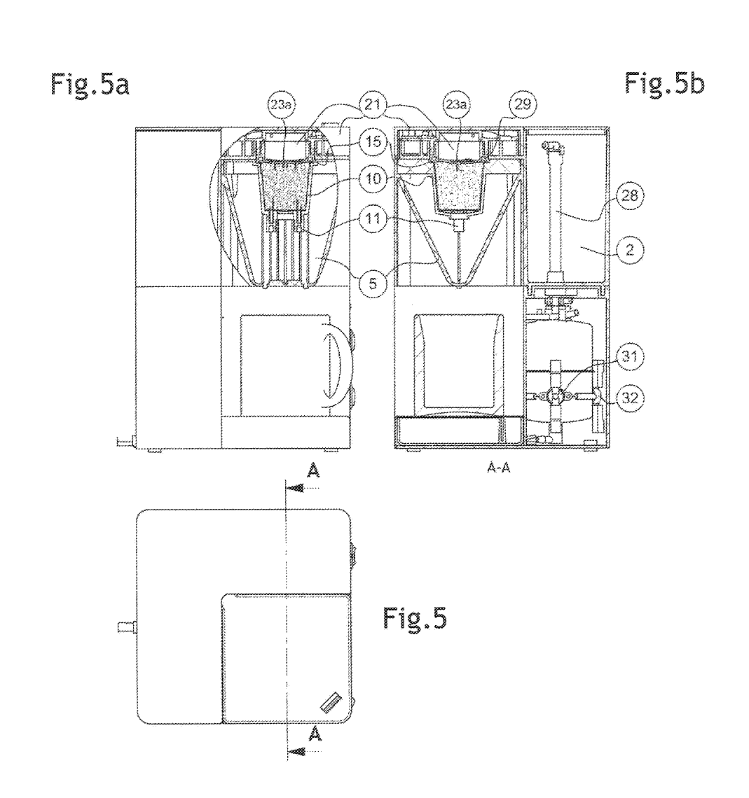

FIG. 5 shows another top view of the apparatus of FIGS. 1 and 2;

FIGS. 5a and 5b illustrate respectively a view partially in cross section of the apparatus of FIG. 4, and a vertical cross section on the Z-Z sectional plane of FIG. 4, provided with a second prearrangement of an apparatus according to the invention;

FIG. 5c illustrates an exploded view and in simplified form of a portion of the apparatus shown in FIGS. 5 and 5b, provided with the second prearrangement according to the invention;

FIG. 5d illustrates the same portion of the apparatus of FIG. 5c, but shown in an assembled mode;

FIGS. 5e and 5f illustrate two figures corresponding to FIGS. 5c and 5d, but in a different variant embodiment;

FIGS. 5g and 5h illustrate two figures corresponding to FIGS. 5c and 5d, but in a different embodiment;

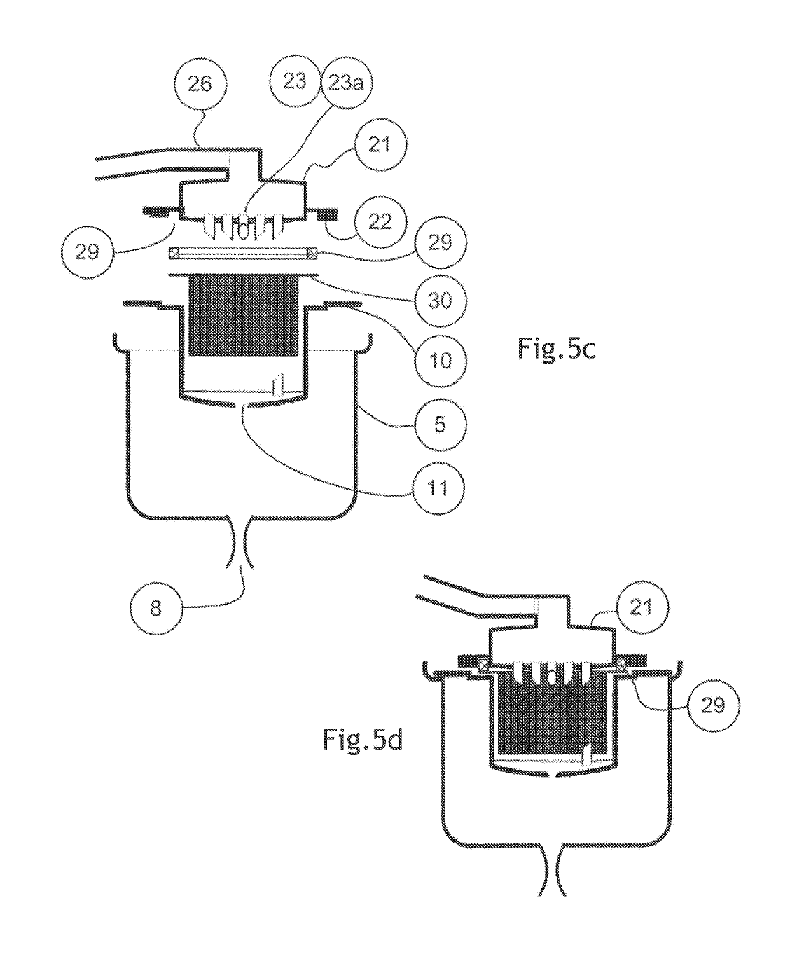

FIG. 6 shows another top view of the apparatus of FIGS. 1 and 2;

FIG. 6A illustrates a vertical cross section according to the sectional plane A-A of FIG. 6, of the same apparatus, which is provided with the second prearrangement shown in figures from 5c to 5h;

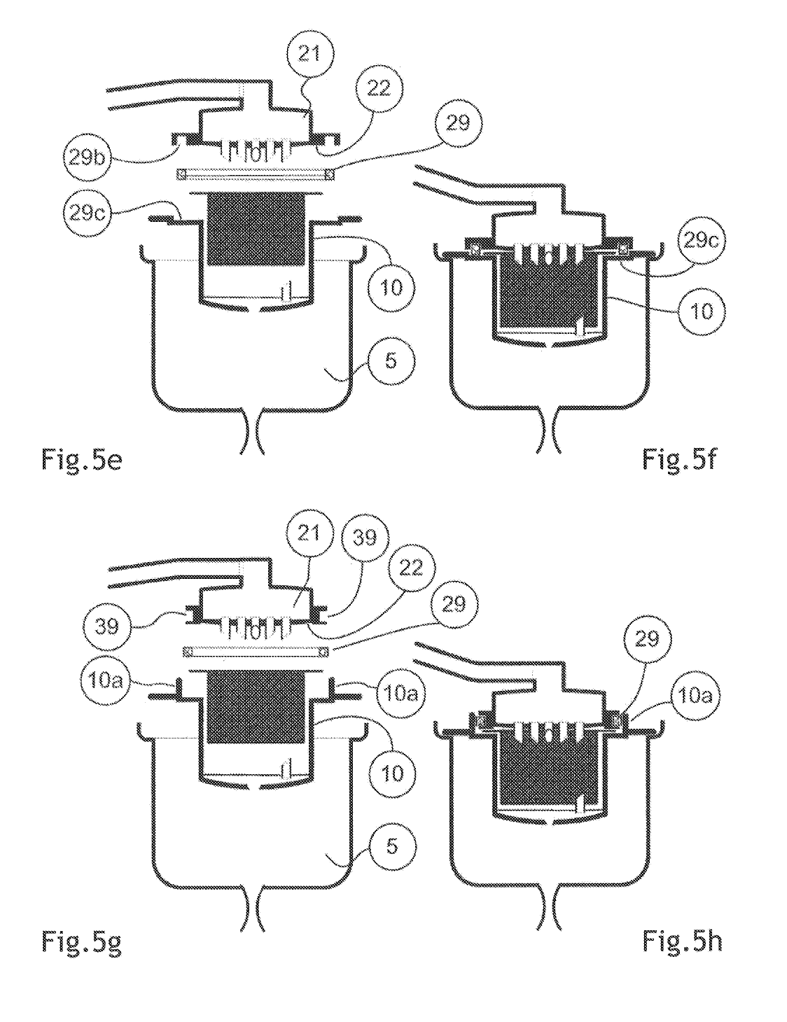

FIGS. 7 and 7A illustrate the apparatus of the previous figures, in two successive prearrangement moments of the same apparatus;

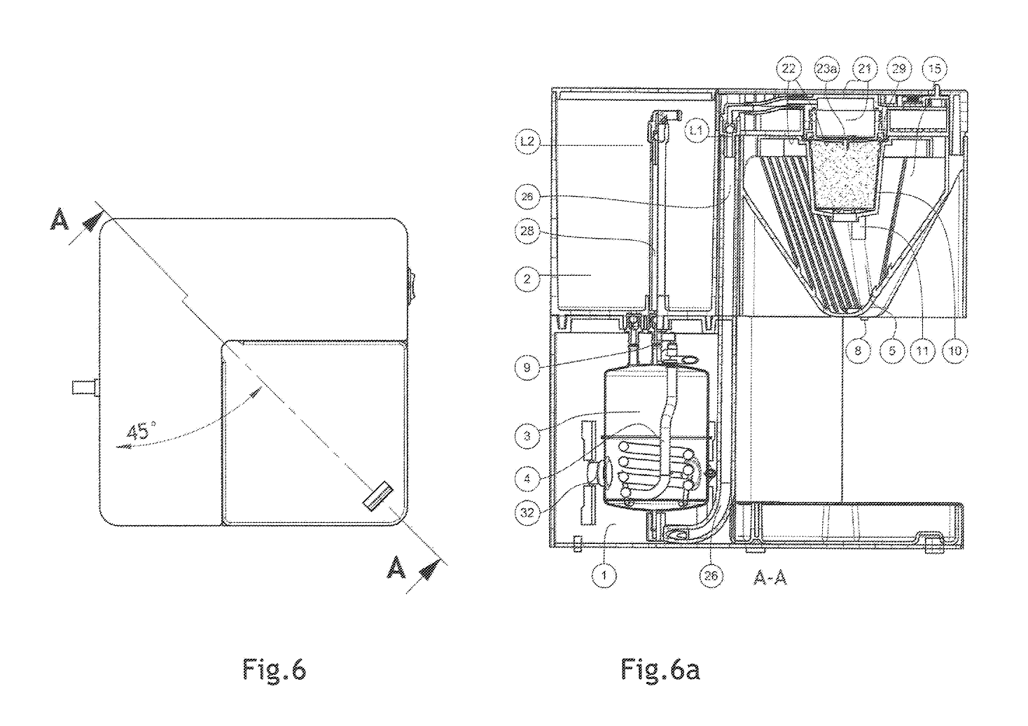

FIGS. 8 and 8A illustrate respective exploded views of the apparatus of the invention;

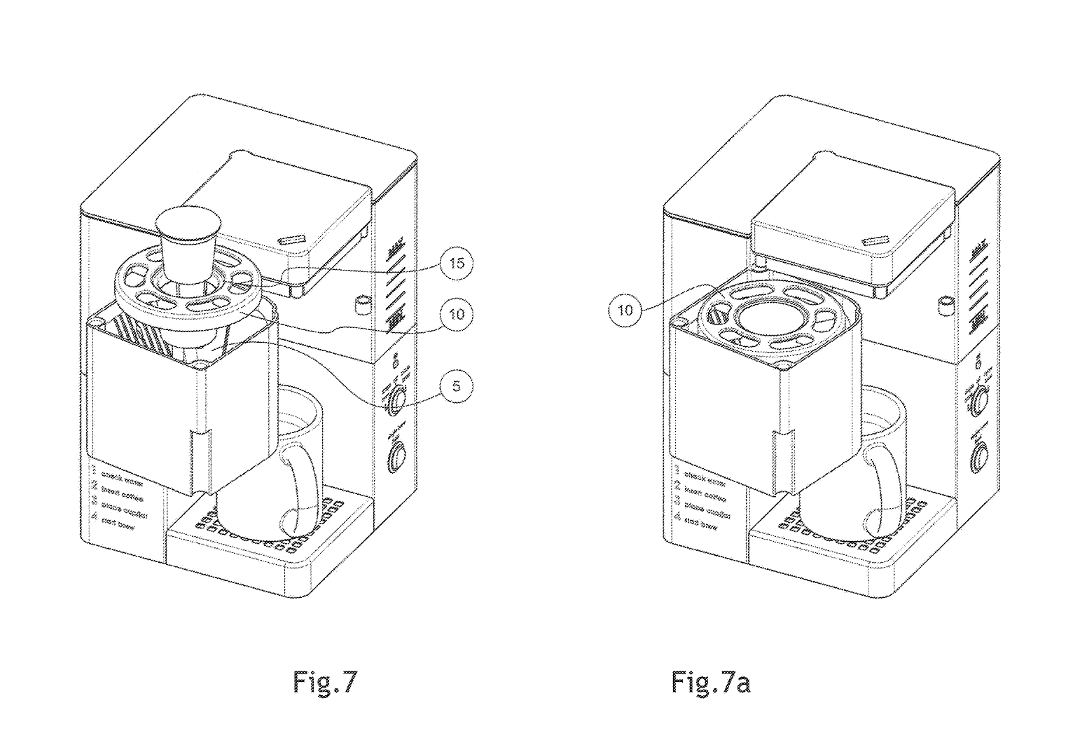

FIGS. 9 and 9A illustrate the simplified diagram of operation of the inventive apparatus according to FIGS. 4c and 4d, in two respective operating modes;

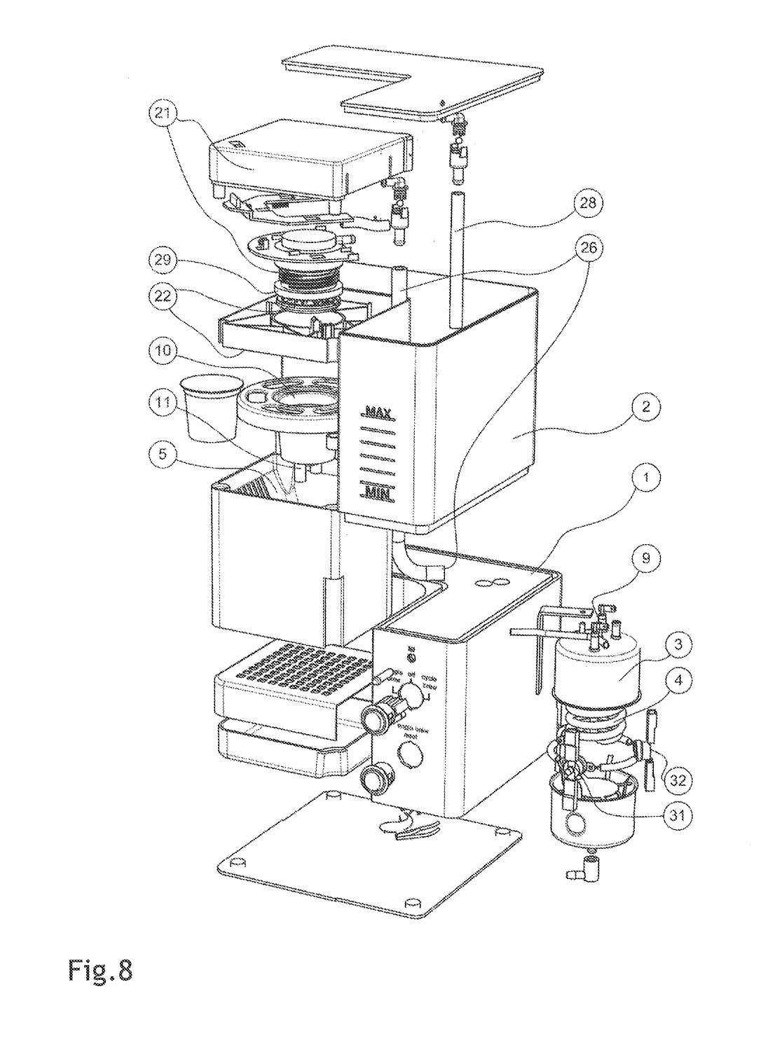

FIGS. 10 and 10A illustrate the simplified diagram of operation of the inventive apparatus according to FIGS. 5c and 5d, in two respective operating modes;

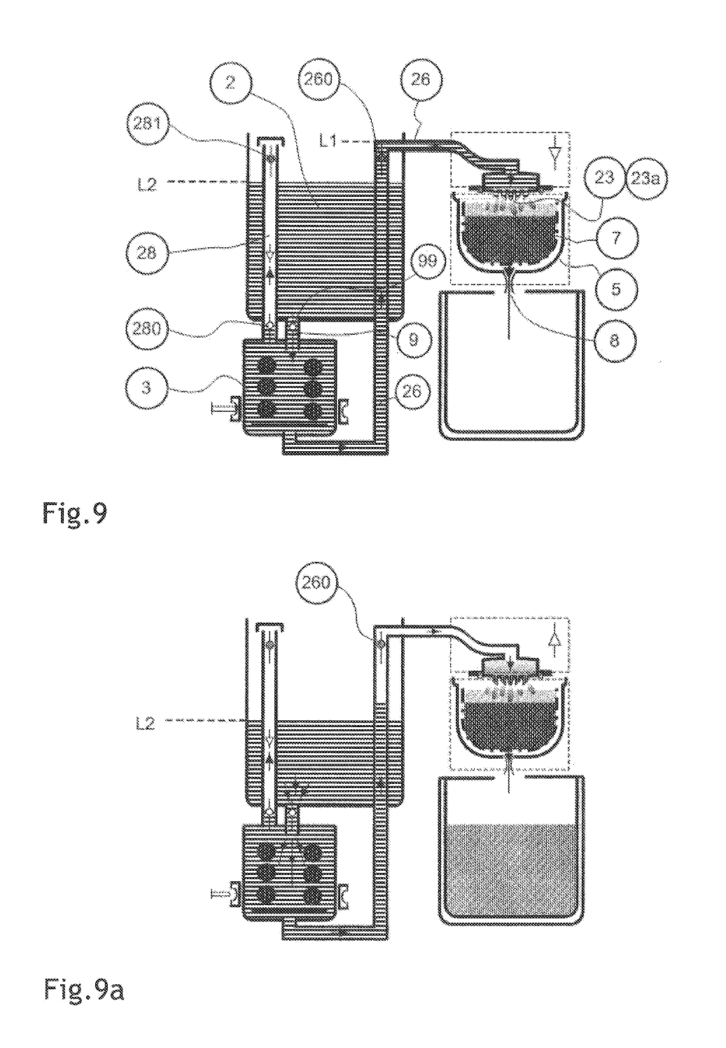

FIGS. 11, 12 and 13 illustrate respective diagrams of operation of the inventive apparatus according to the operating modes of the previous figures.

With reference to the figures, an apparatus according to the invention comprises:
a structure 1 suitable to contain a plurality of devices for the operation of the apparatus, including a reservoir 2 for holding the water to be treated and made into a beverage, a water heating boiler 3 containing an electrical heating element 4;
a first conduit 9 connecting said boiler to the reservoir 2;
an infusion chamber 5.

Said infusion chamber 5, which forms a central element of the invention, is suitable to hold, according to the prior art, a filter 7 that forms the collecting and holding element of the ground coffee or of the substance that is to be turned into an infusion or beverage.

Normally, said infusion chamber 5 is filled from above with a flow of very hot water, at a pressure similar to or slightly higher than the ambient pressure, which flows into the filter and then percolates through the powder or product used for the infusion.

In its passage through said product, the water absorbs the substances of the same and flows down by gravity on the filter, generally made from a sheet of porous paper or similar material, and shaped with a closed and concave bottom.

Below said bottom, said infusion chamber ends in a funnel shape, which naturally includes a lower outflow channel 8.

Under said channel 8 is placed a container opened at the top, such as a cup or a pot, into which pours naturally the infused liquid.

According to the prior art as just described, said method and the relative machine are made so as to be able to produce and pour into said pot a quantity of beverage sufficient for a number of separate doses, and preferably at least half a dozen individual doses; from said pot, each user collects a single dose and pours it into the respective personal cup.

This situation, as is known, features some evident characteristics of simplicity and economy, but also has two well-known shortcomings, which consist of the fact that:
it is not generally possible to produce a quantity of beverage for a single dose; this depends on the fact that the apparatus is optimized to produce in a continuous mode a plurality of doses, and therefore a different use, even when it is possible, causes a worsening of the operating conditions of the apparatus, in particular for what concerns energy economy and the time required;
moreover, the quality of the beverage prepared in this manner, meaning with this set of its characteristics, is considerably lower than the quality of a beverage made with the method known as “espresso”, that is with an addition of hot water under pressure into the product to be infused.

Thus, the apparatus of the present invention is provided with selectively applicable means, suitable:
for the preparation of a single beverage dose through the pressure infusion method (espresso coffee), or as an alternative
for the preparation of a beverage in multiple doses through the method of gravity percolation or fast infusion of the “pour over” type (coffee of filter type or also called “American style coffee”).

For this purpose, the invention introduces a second accessory 10 (different from the first accessory consisting of the well-known paper or metal filter 7 of disposable type), that is cup shaped, suitable to contain a quantity of product in powder, or in a prepacked form like pods, bags, or other packets for single doses of beverage.

Said second accessory 10 is provided with an opening with an upper edge 15 through which is inserted not only the product, but is also supplied a predefined quantity of hot water under a normally low pressure.

Moreover, said accessory is also provided, in its lower portion, with one or more outflow conduits 11 that empty into said infusion chamber 5, and typically above said lower outflow channel/channels 8 on the gravity percolation/fast infusion chamber 5.

To complete the prearrangement of the gravity percolation/fast infusion chamber 5, it is provided with a removable cover 21, provided with a lower surface 22, that is applied on the upper opening of the gravity percolation/fast infusion chamber 5 so as to close it, but not hermetically.

The dimensions and the reciprocal geometry of said gravity percolation/fast infusion chamber 5, and of said accessory 10, are such as to make it possible:
to remove the filter 7;
and to house in a stable, but naturally removable manner, said second accessory 10 inside the gravity percolation/fast infusion chamber 5.

According to the invention, when the cover 21 is closed on the infusion chamber 5, its lower surface 22 is pushed against said upper edge 15 of said second accessory 10, so as to close it hermetically in this case.

Said cover 21 is also provided with a through hole 23 or, in a preferred embodiment, with multiple pointed nozzles 23A through which the flow of hot water is injected into the infusion chamber 5.

However, said through hole 23 or nozzles 23A are arranged in such a position as to open directly inside said second accessory 10, so that the water flows from outside directly inside the second accessory 10.

A direct consequence of this is that it excludes the direct flow of the hot water into the gravity percolation/fast infusion chamber 5.

Here the hot water performs its function of leaching out the substances held inside the second accessory 10, and it flows down by gravity but mostly by effect of hydraulic pressure through the outflow conduit 11 and then through said lower outflow channel/cannels 8 of the infusion chamber 5, to finally flow outside of said chamber.

At this point it will be evident that:
if said second accessory 10 is filled with a single dose of product, that is, with a quantity of product required for a single dose of beverage;
and if through said hole 23 is fed a quantity of hot water at a pressure sufficient for a single dose,
   then it is clear that a beverage is being produced with the “espresso coffee” method, since all the requirements are satisfied.

In practice, according to the invention, the apparatus suitable to produce a multiple beverage according to the filter-coffee method, called “gravity percolation/fast infusion” is transformed in a fast, simple and safe manner into a machine that can be perfectly used to brew beverages of the “low pressure espresso coffee” type.

This machine has numerous, very advantageous possibilities of improvement, as described below:

1) With reference to figures from 5c to 5h, a useful improvement consists of arranging between said cover 21 and the upper edge 15 of the upper opening of the second accessory 10 a suitable gasket 29, that presses against the lower surface 22 of the cover 21 and thus improves and guarantees the relative hermetic sealing between said two elements.

This solution with the gasket makes it possible for the internal volume of the second accessory 10 to be pressurized by the pressure of the hot water coming from the conduit 26, even if the same cover 21 is not capable to hermetically close the internal volume of the part of the infusion chamber 5 that is located externally to said second accessory 10.

Said gasket 29 can be applied with three different variants:
in a first variant, shown in FIGS. 5c and 5d, said lower surface 22 of the cover 21 is provided with a suitable groove 29A, turned downward and having a reduced diameter such as to tightly surround said nozzles 23A; the purpose of such a configuration is to use said groove to apply therein, from below, said gasket 29 so that the gasket acts directly on the capsule containing the product, typically coffee, and acts precisely on the external edge 30 that extends horizontally from the capsule which, in FIG. 5c, is partially inserted into the accessory 10; in this manner is automatically formed a direct conduit that crosses the capsule without any leaks, and thus has the function of forming for a short section the conduit of boiling water.
In a second variant, shown in FIGS. 5e and 5f, said lower surface 22 of the cover 21 is provided with a suitable groove 29B, turned downward and having a diameter that is generally larger than in the previous case; the purpose of this configuration is to use such groove to apply said gasket 29 from below so that the gasket acts not on the capsule that contains the product, but acts instead on the external edge 29C, which extends horizontally from the upper entrance opening of the same second accessory 10; in this manner is connected the conduit from the boiler, which continues in effect as one with the internal volume of said second accessory 10; since said accessory contains the product, in the form of capsules or in bags, or even in loose form, it is in any case guaranteed that this product is always traversed by the flow of boiling water.
In a third variant, shown in FIGS. 5g and 5h, said lower surface 22 of the cover 21 is provided with a suitable side groove 39, facing outward and having a diameter slightly larger than the diameter of the cover 21; in addition, said second accessory 10 is provided with an upper edge 10A of cylindrical shape, projecting toward said cover 21 arranged above it, as can be seen in FIGS. 5g and 5h; the position and the dimensions of said edge 10A and of said side gasket 29 are such that, when said cover 21 is closed, said side gasket 29 is engaged and compressed against the inside surface of said edge 10A (see FIG. 5h), thus providing the desired hermetic seal.

It will also be evident that from the hydraulic point of view, the configuration of FIGS. 5e and 5f is completely identical to the configuration of FIGS. 5g and 5h, since in both cases there is the joining of the conduit that comes from the boiler and in effect continues as one with the internal volume of said second accessory 10.

2) In addition, with reference to figures from 9 to 10A, it is advantageous that the general configuration of the apparatus is formed with and/or includes:
a structure 1 having the function of a frame 1;
a water reservoir 2;
a boiler 3 arranged under said reservoir 2 and connected to the inside of the same with a first conduit 9;
a water heating element 4, arranged inside said boiler 3 and selectively fed with means and modes that will be better defined hereafter;
a second conduit 26 that connects the internal volume of said boiler 3 to said cover 21 and in particular to said hole 23 or multiple nozzles 23A, and suitable to allow a flow of water from said boiler toward the inside of said infusion chamber 5;
a third conduit 28 that hydraulically connects the internal volume of the boiler 3 with the atmosphere at a level “L1” higher than the level “L2” of the water in the tank 2.

The purpose of this solution is to prevent the air, or the water vapour, that may be present or may form inside the boiler at the beginning of the heating phase, from interfering with the flow of fresh water from the reservoir; thus said third conduit 28 has the function of allowing the venting of any quantity of air/steam from the boiler, in the initial boiler heating phase.

It should also be considered that this flow of water vapour also carries with it some water droplets from the boiler; it would be convenient to retrieve these water droplets, both to obviate the necessity of topping up the reservoir 2 too frequently, and mostly because otherwise they would be scattered in the outside environment and require a controlled operation.

To avoid said disadvantages, said third conduit 28 is made to pass vertically from the boiler 3 through the reservoir 2, so that the water droplets coming out of its outlet opening 30 fall naturally on the surface of the water in the reservoir 2.

Naturally, it would be possible to have a slightly different solution, in which said third conduit 28 comes out of the boiler 3 without crossing the reservoir 2; however, for the sake of simplicity, this simple embodiment solution is not illustrated.

To prevent the water being heated and boiling from returning from the boiler 3 to the reservoir 2 through said first conduit 9, it is also advantageous to provide said first conduit 9 with a first non-return valve (check valve) 99, positioned so as to allow the water to flow only from the reservoir 2 to the boiler 3, but not vice versa.

The usefulness of such first valve 99 is immediately evident when considering that, at the beginning of the boiler heating phase, an initial volume of water vapour forms inside the boiler, and there is also an increase in the water volume, which would have the effect of causing an undesirable “return” of hot water into the reservoir 3.

3) As shown in the same figures, it is also convenient to have said second conduit 26 rise to an upper level “L1 ” that is higher than the level “L2” of the water in the reservoir 2; this desirable characteristic results from the fact that, based on the principle of communicating vessels, the infusion chamber 5 cannot be located at a level lower than said level “L2” and therefore, since the second conduit 26 must necessarily reach said hole 23 from above, the upper level of the conduit 26 must also exceed said level “L2”.

4) It was found by experiment that, as an essential requirement, the second conduit 26 must also be equipped with a relative second check valve 260 oriented in the direction of allowing the water to flow from the boiler 3 to the infusion chamber 5 but not vice versa; in addition, it was found highly preferable that said second check valve 260 be arranged in the area higher than the relative conduit 26, so that it is not subjected to any significant hydrostatic pressure from the water column that is above it, because otherwise said hypothetical hydrostatic column would hinder significantly the opening of the same valve when the flow of boiling water toward the infusion chamber 5 is generated.

5) Further, in the third conduit 28 is inserted a respective third check valve 280, placed preferably after the outflow from the boiler 3 and oriented in the direction to allow the flow of air away from the boiler 3, but not vice versa.

The function of said third valve 280 is completely similar to the function of the valve 99, and therefore, to be concise, the explanation of the same is omitted.

6) In the third conduit 28 is installed a fourth check valve 281, placed in a position higher than the preceding valve 280, and preferably on the upper outflow 30 of the same third conduit 28; moreover, it is oriented so as to allow the passage of the flow from the boiler 3 toward the outside, but not vice versa.

The function of said fourth valve 281 is to avoid the formation of a vacuum in the boiler when it is emptied into the conduit 26, because, otherwise, that is, if said fourth valve 281 was not present, during and after the emptying of the boiler the air from outside would be “sucked” inside the boiler. The undesirable consequence of this effect would be that the boiler, still very hot, would not be able to rapidly fill again with water from the reservoir, because the first drops of water would immediately turn into a mass of steam that would generate an internal pressure that would prevent the entrance of fresh water from the reservoir 2.

The negative consequence of this hypothetical procedure would be a marked slowing down of all the operation for the preparation of the beverage.

Said fourth valve 281, cooperating with said second valve 260, thus works in the sense that, after the emptying of the boiler, it prevents the outside air to be sucked into the boiler, using therefore the suction pressure that is created, and thus enabling an advantageous speed in the sequence of preparation of subsequent beverages.

A second negative consequence of this slowing down in the boiler filling phase is caused by the exclusion of the use of bimetallic thermostats due to their relatively slow response.

7) A preferred operating mode of operation of the apparatus, and the means for achieving said mode, are now illustrated.

With reference to FIGS. 11, 12 and 13, said apparatus must be able to work:
in both an independent, or so-called “cyclical” mode, until the complete emptying of the reservoir, to produce a quantity of beverage sufficient for a plurality of doses;
and must also be able to produce, upon request, only the water necessary for a single dose of beverage.

Thus, when the operation in the “Multibrew percolation/Multiple dose” mode is required, it is necessary to intermittently heat a flow of water to pour into the filter 7; with this condition, the heating element 4 must be able to work in a cyclical but continuous mode, that is, according to a sequence of ON-OFF type that is repeated in a continuous mode.

The temporary interruption of power supply to the heating element 4 is due to the fact that:
on one hand, the heating element itself must be sufficiently powerful to heat the water in the boiler 3 with the desired speed;
on the other hand, after the required temperature is reached, that is, substantially the boiling point, the heating element must be switched off, for reasons of safety as well as of economy.

For this purpose, and with reference to the wiring diagram of FIG. 11, to set the operation in the “Single brew percolation” mode, a first heating element 4 power supply circuit 30 is used, which includes:

<<in series, said heating element 4, and a first thermal switch 31 suitable to:
detect the temperature of the water inside said boiler, or a temperature correlated to it;
switch off the flow of said current when said preset temperature is reached;
and to be reset only through an external command, preferably manual reset.

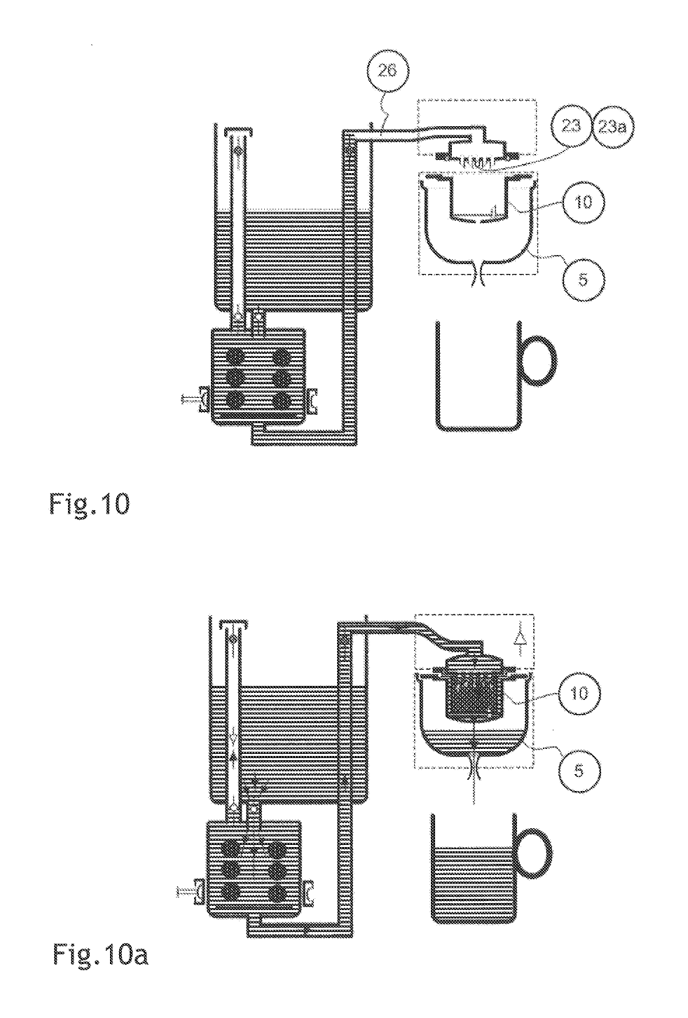

Instead, to effect the operation in the “Multibrew percolator” mode”, a second power supply circuit 35 is used (see FIG. 12) which includes, in series, said heating element 4, and a second thermal switch 32 suitable to:
switch off the flow of said current when said preset temperature is reached;
and working in an automatic and continuous mode, that is, according to a continuous sequence of ON-OFF states, based on the temperature fluctuations inside the boiler 3.

To an expert in the field it will now be clear that, if wishing to prepare a single beverage (such as “Single brew percolation”), it will be necessary to actuate the following combination of prearrangements:

a) install the second accessory 10, and close the cover 21;

b) activate the first power supply circuit 30; this electric circuit must be characterized, both as actuation temperature of the thermal switch 31 and as volume of the boiler 3, so that the water that is heated is present in the proper quantity, that is, neither insufficient nor excessive for the single dose desired, and so that the temperature inside the boiler does not exceed a preset value.

If on the other hand a plurality of beverages is desired (such as “Multibrew percolation”), it will be necessary to actuate the following combination of prearrangements:

a) remove the second accessory 10, and install the filter 7 in its place;

b) activate the second power supply circuit 3; this electric circuit must be characterized, in the operating temperature of the thermal switch 32, in a manner similar to the switch 31, but unlike this it works in an intermittent manner in its phases of:
heating;
subsequent cutting off of the current by the switch 32, when the temperature sensed by the same switch reaches a predetermined value.

All in all therefore, the boiler 3 works as follows:
heating;
subsequent cutting off of the current by the switch 32;
subsequent emptying of the second conduit 26;
subsequent filling of the boiler 3 from the reservoir 2;
subsequent new heating phase (automatic resetting of the switch 32),

c) and so on in an ordered sequence.

8) A further improvement is based on the well-known circumstance that every electric resistance, in the present case together with the relative boiler full of water, has a thermal inertia of its own after having been disconnected, and continues to heat for a certain period, during which its temperature progressively declines.

During this cooling period, it naturally emits thermal energy, which is absorbed naturally by the surrounding quantity of water contained in the boiler.

Thus in this case, by the energy levelling principle, the temperature of the water rises, while the temperature of the heating resistance drops.

Thus, if the operating temperature—that is, the temperature detected in the bath in which the heating resistance is deactivated—is suitably selected and set, the temperature of the water can rise up to the boiling point, and in fact said operating temperature is chosen substantially as the value where the maximum temperature that can be reached in the boiler reaches in fact the boiling temperature.

Taking this fact into account, the operating temperature of the switch 32 is determined not on the boiling temperature in the boiler 3, but on a slightly lower temperature, for example 92° C., the exact value of which must be determined experimentally case by case.

Regardless of how such predetermined value is reached, said switch 32 cuts off the current on the electric resistance 4, the temperature of which then drops progressively for an interval in which the temperature of the water bath in the boiler 3 rises up to the maximum predetermined value, usually around 100° C.

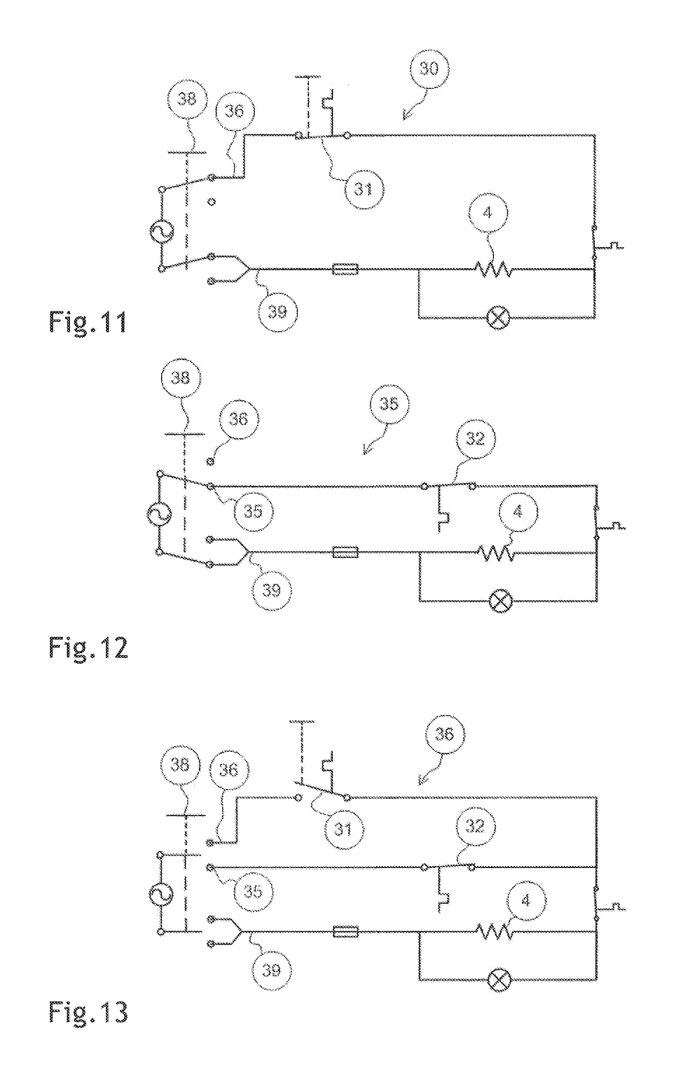

9) A subsequent further improvement is easily obtained if said first circuit 30 and said second circuit 35 are integrated in a more general single circuit 36, shown in FIG. 13, and in which the common part regards substantially the resistance 4.

Advantageously, said two circuits can be selectively connected or disconnected if each of the ends of the respective circuits is connected to the two output ends 36, 37 of a switch 38, the common end of which 39 is stably connected to said common electric resistance 4, where the input ends of said switch 38 are schematically connected to the power supply network.

1-15. (canceled)

16. Multi-function apparatus for the preparation of hot beverages, comprising:
a structure acting as a frame,
a boiler arranged under said reservoir and connected to the inside of it by a first conduit,
water heating means arranged into said boiler and selectively actionable,
an infusion percolation chamber provided with a respective cover and able of lodging a filtering element, apt of containing a definite quantity of product to be subjected to infusion, further comprising selectively mountable means, configured for:
preparing a single dose of beverage by the method of pressure infusion (espresso coffee), or alternatively,
preparing a multiple dose of beverage by the method of percolation.

17. Multi-function apparatus for the preparation of hot beverages according to claim 16, further comprising:
a second accessory shaped as a cup, configured for containing a product quantity for a single-dose beverage,
wherein said second accessory is apt to be lodged into said infusion chamber alternatively to said filtering element.

18. Multi-function apparatus for the preparation of hot beverages according to claim 16, wherein between said boiler and said cover a second conduit is arranged, which is configured for supplying a water flow from said boiler into said infusion chamber.

19. Multi-function apparatus for the preparation of hot beverages according to claim 18, wherein said second conduit raises to a level higher than the top water level into said reservoir.

20. Multi-function apparatus for the preparation of hot beverages according to claim 19, wherein a third conduit is provided to hydraulically connect the inner volume of said boiler to an atmosphere level higher to the water level inside said reservoir.

21. Multi-function apparatus for the preparation of hot beverages according to claim 20, wherein said third conduit at least partly passes through the inner volume of said water reservoir.

22. Multi-function apparatus for the preparation of hot beverages according to claim 17, wherein between an upper edge of said second accessory and a lower surface of said cover a gasket is interposed.

23. Multi-function apparatus for the preparation of hot beverages according to claim 16, wherein
said water heating means comprise an electric resistance,
and an electric circuit is provided which includes two distinct electric power supply circuits, wherein,
the first electric power supply circuit comprises, in series, said electric resistance, and a first thermal switch configured for detecting the water temperature inside said reservoir or a temperature correlated, and of being restored by an external command,
the second power supply electric circuit comprises, in series, said electric resistance and a second thermal switch operating in an automatic mode.

24. Multi-function apparatus for the preparation of hot beverages according to claim 23, wherein the switching temperature of said first thermal switch corresponds to the temperature on which, after the power supply disconnection, the thermal inertia of said resistance and of said boiler allows the temperature inside said boiler to raise up to a temperature level such as a pressure level is generated, which is sufficient for a single-dose beverage through said first conduit.

25. Multi-function apparatus for the preparation of hot beverages according to claim 24, wherein said two power supply circuits are selectively actionable and connectable to an electric power source by a switching means.

26. Multi-function apparatus for the preparation of hot beverages according to claim 23, wherein inside said first conduit a first check-valve is arranged, which is configured for allowing the water flow from said reservoir into said boiler only.

27. Multi-function apparatus for the preparation of hot beverages according to claim 18, wherein inside said second conduit a second check-valve is arranged, which is configured for allowing the water flow from said boiler into said infusion chamber only, said second check valve being arranged in an upper portion of said second conduit.

28. Multi-function apparatus for the preparation of hot beverages according to claim 20, wherein into said third conduit are arranged:
a third check-valve configured for preventing the water flowing from said boiler to the outside,
a fourth check-valve configured for preventing the air and/or water flowing from the outside into said boiler and arranged above said third check-valve.

29. Multi-function apparatus for the preparation of hot beverages according to claim 22, wherein said gasket is placed in a removable way on a groove arranged on said lower surface of said cover, and is configured for engaging with an upper edge of a product container lodged inside said second accessory.

30. Multi-function apparatus for the preparation of hot beverages according to claim 22, wherein said gasket is placed in a removable way on a groove generally arranged on a lower or side part of said cover, and configured for engaging with corresponding upper or side portions of said cover.
